(19) United States
(12) Patent Application Publication
(10) Pub. No.: US 2012/0076898 A1
(43) Pub. Date: Mar. 29, 2012

(54) APPARATUS FOR PROVIDING FLAVOR TO A BEVERAGE CONTAINER

(76) Inventor: Charles H. Brown, III, Carrollton, TX (US)

(21) Appl. No.: 12/891,153

(22) Filed: Sep. 27, 2010

(51) Int. Cl. A23L 2/56; A23L 1/27; A23P 1/08; A23L 1/22; A23P 1/10

(52) U.S. Cl. 426/103; 426/89; 426/576; 426/321; 426/307; 426/303; 426/250

(57) ABSTRACT

A flavor provider for use on a beverage container and method for making the flavor provider is disclosed, wherein the flavor provider has a base layer, an adhesive coating that coats at least a portion of the base layer, and at least one flavor layer applied to at least one of the base layer or the adhesive coating, and wherein the base layer is a gelatin ring or a wax layer.

### BACKGROUND OF INVENTION

1. Field of the Invention

Embodiments disclosed herein relate generally to a flavor provider for use on beverage containers. More specifically, embodiments relate to flavor providers that may be provided separately from or affixed to beverage containers.

2. Background Art

Drinks are often times supplemented with an additional flavor that may be added in different proportions. For example, flavored syrups, such as cherry or vanilla flavor, are often added to sodas. These flavored syrups may be added during or after manufacture of the sodas. Alternatively, flavors have been formed into solid yet dissolvable tablets that may be added to a drink subsequent to production of the drink to add the supplemental flavor to the drink, such as described in U.S. Patent Application Publication No. 2008/0187628. Such methods of supplementing flavor to drinks provide little flexibility and control to the user of the amount of flavor added to a drink. In particular, once flavor is added to the drink, the amount of flavor cannot be reduced because the amount of flavor added in the drink remains in the drink.

In other prior art methods of supplementing flavors to drinks, the flavor may be added to the rim of a glass or cup. For example, in U.S. Patent Application Publication 2007/0092615, the rim of a glass or cup is manufactured to have an edible appliqué attached thereto so that a user may taste the appliqué upon sipping a beverage from the glass or cup. While this prior art method may provide the user more control over the amount of flavor tasted while drinking a beverage than adding flavored syrup or tablets, the appliqué is attached to the beverage container significantly prior to the time of consumption, which may allow exposure to contaminants. Further, because the appliqué is manufactured to the beverage container, the appliqué may not be transferred to different beverage containers, and the appliqués may not be sold separately from the beverage containers.

Accordingly, there exists a need for a means to supplements drinks with additional flavor that provides users with increased control and transferability of the flavor.

### SUMMARY OF INVENTION

In one aspect, embodiments disclosed herein relate to a flavor provider having a gelatin ring, at least one adhesive coating disposed on at least a portion of the gelatin ring, and at least one flavor layer disposed on the adhesive coating, wherein the gelatin ring includes a gelatin-based material and a preservative.

In another aspect, embodiments disclosed herein relate to a flavor provider having an adhesive layer, a wax layer disposed on the adhesive layer, and at least one flavor layer disposed on the wax layer, opposite from the adhesive layer.

In yet another aspect, embodiments disclosed herein relate to a method of making a flavor provider for use on a beverage container that includes forming a base layer, coating at least a portion of the base layer with an adhesive coating, and applying at least one flavor layer to at least one of the base layer or the adhesive coating.

Other aspects and advantages of the invention will be apparent from the following description and the appended claims.

### BRIEF DESCRIPTION OF DRAWINGS

FIG. 1 is a cross-sectional view of an exemplary embodiment according to the present disclosure.

FIG. 2 shows an exemplary embodiment of a flavor provider disposed on a beverage container.

FIG. 3 is a cross-sectional view of another exemplary embodiment according to the present disclosure.

FIG. 4 shows another exemplary embodiment of a flavor provider disposed on a beverage container.

### DETAILED DESCRIPTION

In one aspect, embodiments disclosed herein relate to methods and apparatuses of providing flavor for use in conjunction with a beverage container. As used herein, a beverage container may refer to containers such as cups or bottles made of glass, plastic, ceramic, metal, or composites used to hold beverages.

Generally, embodiments disclosed herein relate to a flavor provider for use on a beverage container. A “flavor provider” may refer to an apparatus made of edible and flavored material that is positioned adjacent to a beverage container. In particular embodiments, a flavor provider may include a base layer, an adhesive coating, and a flavor layer. Flavor providers of the present disclosure may be formed in particular configurations to provide at least one of the following: a lickable surface area, transferability, and protection from contaminants.

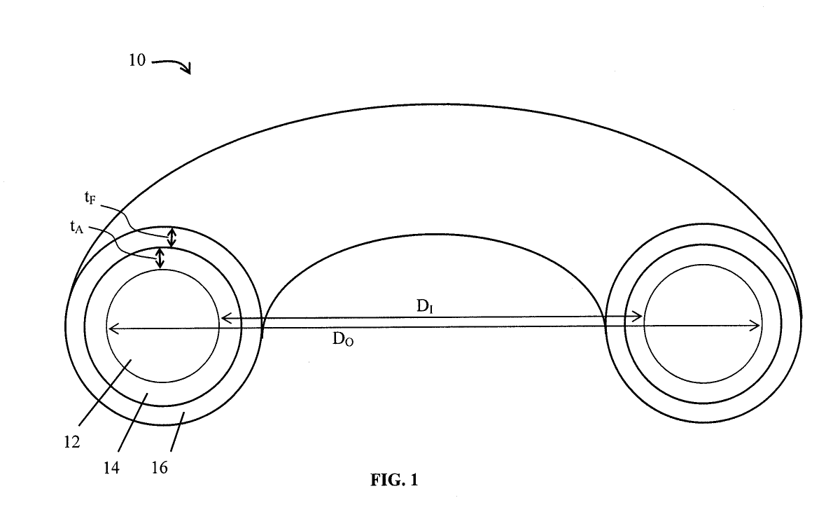

Referring now to FIG. 1, a cross-section view of an exemplary embodiment of a flavor provider having a base layer, an adhesive coating, and a flavor layer is shown, wherein the base layer is a gelatin ring. As shown, a flavor provider 10 includes a gelatin ring 12, an adhesive coating 14 applied to at least a portion of the gelatin ring 12, and a flavor layer 16 applied to the adhesive coating 14. The gelatin ring 12 may be circular in shape, wherein the gelatin ring has an inner diameter D_{I} and an outer diameter D_{O}. The adhesive coating 14 and flavor layer 16 in the embodiment shown in FIG. 1 coat the entire gelatin ring 12. However, in other embodiments, the adhesive coating and flavor layer may coat less than the entire gelatin ring. For example, in certain embodiments, the adhesive coating and flavor layer may be applied to the gelatin ring such that portions of the gelatin ring remain uncoated. One such embodiment may have an adhesive coating and flavor layer coating the outer diameter of the gelatin ring, while at least a portion of the inner diameter (i.e., interior portion) of the ring remains uncoated. Leaving at least a portion of the ring uncoated may be advantageous, for example, when the ring is provided on a beverage container having condensation thereon or which is cold and may later develop condensation, because the condensation may cause either the adhesive coating and/or the flavor layer to dissolve and/or run down the sides of the beverage container.

According to embodiments of the present disclosure, the ring may be made of a gelatin-based material and one or more preservatives, such as an acid, for example. However, in other embodiments, the ring may be made of other materials, for example, wax, starch, pectin, plastic, organic materials and/or other materials which may be molded into a ring form. For example, the ring may be made using a confectioner's wax, paraffin, carnauba wax, or beeswax. In some embodiments, the one or more preservatives may be an acid, for example, citric acid, or other preservative known in the art, including organic preservatives. In yet other embodiments, the ring may include a smelling additive, for example, lemon and/or orange oil, which may be added to the mixture used to form the ring and/or added to the ring after it has been formed. In yet other embodiments, the ring may include food coloring in order to give the ring a particular color, for example, green food coloring for a lime flavored ring or orange food coloring for an orange flavored ring, etc.

Applicant notes that although specific examples are provided herein, these are used solely as examples and are not intended to be limiting on the present invention. Specifically, the material used to make the ring may be edible or inedible; the preservative may be acidic or basic (or neutral); the smelling additive may be oil-based or water-based; and any of the ingredients may be considered organic.

In a preferred embodiment of the present invention, a gelatin ring may be made by mixing a powdered gelatin-based material with water and applying heat until the powdered gelatin-based material dissolves or liquefies. Preferably, the mixture should be heated to just under boiling or to boiling, in order to ensure the gelatin will solidify. The gelatin liquid may then be poured into a ring-shaped mold and cooled until the gelatin hardens. In an exemplary embodiment, a gelatin to water ratio may range from about 10 parts gelatin to 1 part water (10:1) to about 20 parts gelatin to 1 part water (20:1). A preservative, and optionally, a smelling additive, may also be added to the mixture of gelatin-based material and water. For example, a preservative ratio may range from 200 parts gelatin to 1 part preservative (200:1) to 300 parts gelatin to 1 part preservative (300:1). A smelling additive may be added so that the smelling additive ratio ranges from 100 parts gelatin to 1 part smelling additive (100:1) to 150 parts gelatin to 1 part smelling additive (150:1).

Referring back to FIG. 1, an adhesive coating 14 may be applied to at least a portion of a formed gelatin ring 12. The adhesive coating 14 may applied to the gelatin ring 12 so that the adhesive coating has a thickness t_{A} ranging from about 2 mm to about 8 mm, and more preferably from about 2.5 mm to about 7.6 mm. The adhesive coating thickness t_{A} may be uniformly or non-uniformly coated around the circumference of the gelatin ring 12. For example, in some embodiments, the adhesive coating may be applied to the gelatin ring in a low viscosity form, wherein the adhesive coating material tends to flow in the direction of gravity, and thus, may pool or collect at the bottom of the gelatin ring. In other embodiments, an adhesive coating material may be applied to the gelatin ring in a higher viscosity form, wherein the adhesive coating material may form a coating having a substantially uniform thickness.

An adhesive coating may be made from sugar and water to form a syrup material. For example, in certain embodiments, 1.5 parts of a sugar material may be added to 1 part boiling water and stirred until the sugar dissolves in the water. In other embodiments, a sugar to water ratio may range from 1:1 (i.e., 1 part sugar to 1 part water) to 2:1. The mixture may then be heated for an additional amount of time to thicken the mixture, i.e., increase the viscosity of the adhesive coating material.

Furthermore, in some embodiments, a gelatin ring may be coated with an adhesive coating by brushing adhesive coating material on a first side of the gelatin ring, allowing the first side to dry, and then brushing adhesive coating material on a second side of the gelatin ring. In other embodiments, the gelatin ring may be dipped in an adhesive coating material, such that at least a portion of the gelatin ring is coated by the adhesive material. Once the adhesive coating is applied, a flavor layer may be applied to the adhesive coating.

Referring again to FIG. 1, a flavor layer 16 may be applied to the adhesive coating 14 so that the flavor layer 16 has a thickness t_{F} ranging from about 2 mm to about 6 mm, and more preferably, from about 2.5 mm to about 5.08 mm. Further, the flavor layer thickness t_{F} may be uniformly or non-uniformly applied over the adhesive coating 14. The thickness of the flavor layer may depend on, for example, the flavor layer material and the method of application. For example, in embodiments with a flavor layer having granulated sugar, the thickness of the flavor layer may be at least the size of the sugar granules forming the flavor layer. In other embodiments with a flavor layer having powdered sugar, for example, the thickness of the flavor layer may be at least the size of the powdered sugar granules forming the flavor layer. In yet other exemplary embodiments, a flavor layer made of salt may have a thickness of at least the size of the salt grains forming the flavor layer.

A flavor layer may include a powdered or granulated flavor material, such as salt or a mixture of a sugar and one or more flavored extract. For example, according to some embodiments of the present invention, the flavor layer may be made of a salt and/or sugar mixed with at least one flavor. In other embodiments, the flavor layer may be made with the flavored extract and only a limited amount of salt and/or sugar (or none at all) in order to form a flavor layer that is, for example, low sodium or sodium free and/or low sugar or sugar free. Additionally, in some embodiments, the flavor layer may be in liquid, rather than granulated, form, so as to provide a smooth flavor layer to the ring. According to one or more embodiments of the present invention, the flavor extracts may include, for example, cherry, lemon, lime, peach, watermelon, strawberry, raspberry, pineapple, vanilla, chocolate, orange, mint, banana, coconut, grape, mango, papaya, tamarindo, chamoy, cucumber, chile, root beer, tomato, tomato chili, michelada, and many other flavors.

In some embodiments, a flavor layer may include more than one flavor. Exemplary flavor combinations may include a combination of salt and lime flavor, a combination of sugar, cherry, and vanilla flavor, a combination of sugar, lime, and mint flavor, or a combination sugar, coconut, and banana flavor, for example.

Furthermore, multiple flavor layers may be applied to a base layer so as to provide various sensations throughout the drinking experience. In particular, a first adhesive coating may be applied to a base layer, such as a gelatin ring, and a first flavor layer may be applied to the first adhesive coating. A second adhesive coating may then be applied to the first flavor layer, and a second flavor layer may be applied to the second adhesive coating. For example, in certain embodiments, a flavor provider may have a gelatin ring, a first adhesive coating, a first flavor layer made with lime extract, a second adhesive coating, and a second flavor layer made with salt. In other embodiments having more than one flavor layer, different flavor combinations may be made.

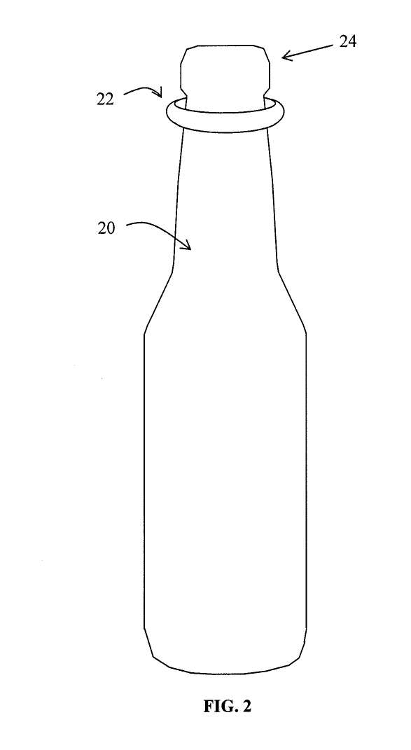

Referring now to FIG. 2, a side view of a beverage container 20 having a flavor provider 22 according to embodiments of the present disclosure disposed thereon is shown. In particular, FIG. 2 shows a flavor provider 22 that is capable of fitting over the top 24 of a beverage container 20. The flavor provider may be made of a gelatin ring coated with an adhesive coating and flavor layer, such as described above, wherein the inner diameter of the gelatin ring is large enough to fit around the top of the beverage container.

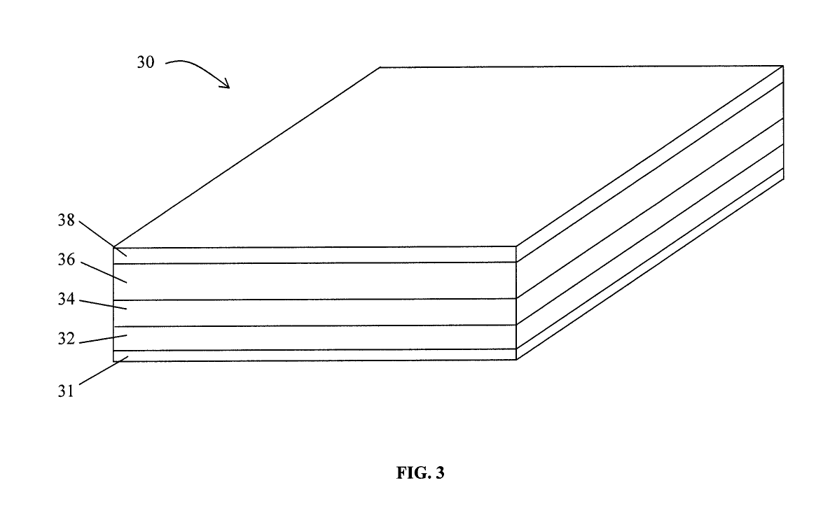

According to other embodiments of the present disclosure, a flavor provider may include a base layer, an adhesive coating, and a flavor layer, wherein the base layer is a wax layer. In such embodiments, the wax layer may be disposed between the adhesive coating and the flavor layer, such that the flavor provider may be adhered to an outer side of a beverage container. Further, the flavor layer may be applied directly to the wax layer (rather than on an adhesive coating applied to the wax layer) when the flavor layer is applied to the wax layer in a soft or melted form. For example, referring to FIG. 3, a flavor provider 30 has an adhesive layer 32, a wax layer 34 adjacent to the adhesive layer 32, a flavor layer 36 adjacent to the wax layer 34, opposite from the adhesive layer 32, and a removable protective cover 38 adjacent to the flavor layer 36, opposite from the wax layer 34. Additionally, a non-adhesive layer 31 may be disposed adjacent to the adhesive layer 32. When the flavor provider is ready for use, the non-adhesive layer 31 may be removable to expose the adhesive layer 32 and apply to the outer side of a beverage container.

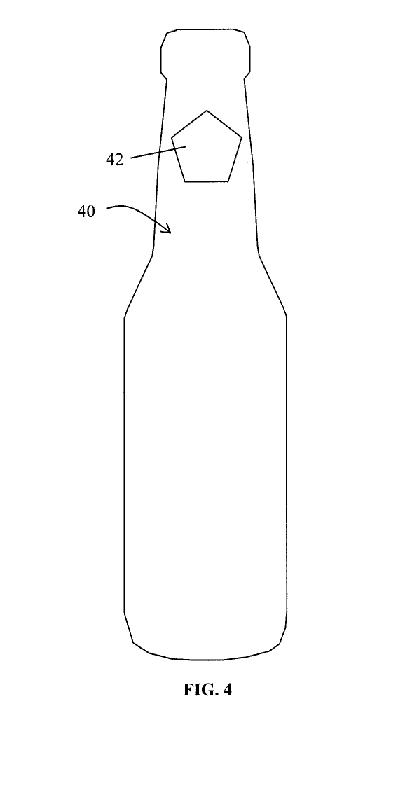

Referring now to FIG. 4, a side view of a beverage container 40 having a flavor provider 42 according to embodiments of the present disclosure, such as the one shown in FIG. 3, is shown. In particular, FIG. 4 shows a flavor provider 42 adhered to a side of a beverage container 40. In the embodiment shown in FIG. 4, the flavor provider 42 has a pentagon shape. However, in other embodiments, the flavor provider may have other shapes, including other types of polygons, rectangles, triangles, circular shapes, irregular shapes, symbols, and designs, for example. Further, the flavor provider shown in FIG. 4 may be flat and relatively smooth, or the surface of the flavor provider may be textured.

A flavor provider, such as the ones shown in FIGS. 3 and 4, may be made by melting a wax material, such as paraffin wax, and pouring the melted wax onto an adhesive coating. The wax material may also include, for example, a gum-based material and optionally a food coloring. A flavor layer may then be applied to the melted wax material before the wax cools and hardens. In particular, the flavor layer may adhere to the wax layer without the use of an additional adhesive coating while the wax is in a softened or melted state, thus allowing the flavor layer to be applied directly to the wax layer. Once the flavor layer is applied to the wax layer, the wax material may be cooled. However, in some embodiments, an additional adhesive coating may be applied to the wax layer and the flavor layer applied to the adhesive coating. The flavor layer may be made of at least one of a salt, a sugar-based material, a preservative, such as citric acid, and a flavored extract, such as cherry, lemon, lime, mint, banana, coconut, orange, and vanilla, for example. The materials forming the wax layer and flavor layer may be edible.

A removable protective cover may be placed adjacent to the flavor layer (opposite from the wax layer). In exemplary embodiments, the protective cover may be paper, foil, plastic, or other material. Advantageously, the protective cover may protect the edible materials of the flavor provider, such as the flavor layer, from contaminants.

Additionally, a non-adhesive layer may be disposed adjacent to the adhesive layer of a flavor provider, such that the non-adhesive layer may be removed or peeled away to expose the adhesive layer. A non-adhesive layer may include, for example, foil, paper, polymers, etc. For example, in some embodiments, a flavor provider may have a non-adhesive layer made of paper and/or plastic having a thin non-adhesive polymer layer coated thereon.

### EXAMPLES

### Example 1

A gelatin ring is formed by mixing about 15 ounces of powdered gelatin with about 30 mL of water. The mixture is heated to a temperature below the boiling point and stirred until the powdered gelatin is liquefied. 1/16 teaspoon of citric acid powder (a preservative) and ⅛ teaspoon of lemon oil (smelling additive) is added to the mixture. The liquid gelatin mixture is poured into a ring-shaped mold and cooled. Once it is hard, the gelatin ring is removed from the mold and an adhesive coating is applied thereon. The adhesive coating is made by adding 1.5 parts sugar to 1 part boiling water and stirring until the sugar is dissolved. Once the sugar has dissolved, the mixture boils for about a minute more so that the mixture will thicken into an adhesive coating material. The adhesive coating material is applied to at least a portion of the hardened gelatin ring. Once the adhesive coating has dried onto the gelatin ring, the coated gelatin ring is dipped into a flavor material such that a flavor layer is formed on the adhesive coating.

### Example 2

A flavor provider is made by heating 1 ounce of edible paraffin wax until it is melted. The liquid wax is then poured onto a piece of self-adhesive laminate (an adhesive layer). The self-adhesive laminate has a removable non-adhesive layer on the side opposite from the wax, which may later be removed to expose an adhesive surface. While the wax is still in heated liquid form, ½ teaspoon of flavor material is sprinkled onto the wax to form a flavor layer. Flavor material may include one of salt, citric acid, sugar, orange, vanilla, or cherry, for example. The wax is then cooled until it solidifies and a removable protective cover is placed over the flavor layer. When the user is ready to use the flavor provider, the non-adhesive layer may be removed from the adhesive layer, and the flavor provider may be adhered to a beverage container.

Advantageously, embodiments of the present disclosure may allow for a more sanitary method of providing flavor to a beverage container when compared to prior art flavor providers. Additionally, flavor providers of the present disclosure allow for easy transferability between beverage containers and/or for individual retail sale. For example, by making flavor providers according to the present disclosure, manufacturers may not need to integrate the beverage container at the time of making the flavor provider. Thus, flavor providers may be made and sold separately from the beverage container, which may decrease manufacturing and shipping costs. Furthermore, flavor providers of the present disclosure may allow for increased control in the amount of flavor experienced while drinking a beverage from a beverage container. In particular, the user of the flavor provider controls how much flavor is licked from the flavor provider prior to or after consuming the beverage from a beverage container. Additionally, embodiments of the present invention may allow for flavor to be provided and maintained on a beverage container that either has condensation thereon or which later produces condensation, thereby retaining flavor and keeping the beverage container clean. Furthermore, embodiments disclosed herein may prevent excess waste of flavor by providing the flavor in a finite form rather than in a powdered form.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A flavor provider for use on a beverage container, comprising:
a gelatin ring, comprising:
a gelatin-based material; and
a preservative;
at least one adhesive coating, wherein the at least one adhesive coating is disposed on at least a portion of the gelatin ring; and
at least one flavor layer, wherein the at least one flavor layer is disposed on the adhesive coating.

2. The flavor provider of claim 1, wherein the at least one flavor layer comprises at least one of a salt, a sugar, a flavored extract, and combinations thereof.

3. The flavor provider of claim 1, wherein the gelatin ring further comprises a smelling additive.

4. The flavor provider of claim 3, wherein the smelling additive is lemon oil.

5. A flavor provider for use on a beverage container, comprising:
an adhesive layer;
a wax layer disposed on the adhesive layer; and
at least one flavor layer disposed on the wax layer, opposite from the adhesive layer.

6. The flavor provider of claim 5, further comprising a removable protective cover disposed on the flavor layer, opposite from the wax layer.

7. The flavor provider of claim 5, wherein the at least one flavor layer comprises at least one of a salt, a sugar, and a flavored extract.

8. The flavor provider of claim 5, wherein the wax layer comprises an edible paraffin wax.

9. The flavor provider of claim 5, further comprising a non-adhesive layer disposed adjacent to the adhesive layer, wherein the non-adhesive layer is removable.

10. The flavor provider of claim 5, wherein the wax layer comprises a gum base.

11. The flavor provider of claim 5, wherein the wax layer comprises a food coloring.

12. A method of making a flavor provider for use on a beverage container, comprising:
forming a base layer;
coating at least a portion of the base layer with an adhesive coating; and
applying at least one flavor layer to at least one of the base layer or the adhesive coating.

13. The method of claim 12, wherein the base layer is a gelatin ring.

14. The method of claim 13, wherein forming the gelatin ring comprises:
mixing a gelatin-based material and water;
heating the gelatin-based material and water;
adding a preservative; and
pouring the mixture in a ring-shaped mold.

15. The method of claim 14, further comprising:
adding a smelling additive.

16. The method of claim 13, further comprising:
forming the adhesive coating,
wherein forming the adhesive coating comprises:
boiling water;
adding a sugar to the water; and
heating the mixture for a period of time.

17. The method of claim 12, wherein the flavor layer comprises at least one of a salt, a sugar, a flavored extract, and combinations thereof.

18. The method of claim 12, wherein the base layer is a wax layer.

19. The method of claim 18, wherein forming the wax layer comprises:
melting a paraffin wax; and
pouring the melted paraffin wax onto the adhesive coating.

20. The method of claim 19, further comprising:
covering the adhesive coating with a removable non-adhesive layer opposite from the wax layer.

21. The method of 19, further comprising:
applying a flavor layer onto the melted paraffin wax; and
cooling the melted paraffin wax.

22. The method of claim 21, further comprising:
applying a protective cover on the flavor layer, opposite from the paraffin wax.

23. The method of claim 19, further comprising:
adding a gum base to the melted paraffin wax.

24. The method of claim 19, further comprising:
adding a food coloring to the melted paraffin wax.
